(19) United States
(12) Patent Application Publication
(10) Pub. No.: US 2024/0161509 A1
(43) Pub. Date: May 16, 2024

(54) SENSING DEVICE AND LOADING RATE ESTIMATION SYSTEM

(71) Applicant: Isuzu Motors Limited, Yokohama-shi, Kanagawa (JP)

(72) Inventors: Maya MATSUSHITA, Fujisawa-shi, Kanagawa (JP); Tomoaki SHIMOZAWA, Fujisawa-shi, Kanagawa (JP); Yuka MIZUSHI, Fujisawa-shi, Kanagawa (JP)

(73) Assignee: Isuzu Motors Limited, Yokohama-shi, Kanagawa (JP)

(21) Appl. No.: 18/282,822

(22) PCT Filed: Mar. 15, 2022
(86) PCT No.: PCT/JP2022/011559

§ 371 Date: Sep. 19, 2023

(30) Foreign Application Priority Data
Mar. 24, 2021 (JP) 2021-049745

(51) Int. Cl. G06V 20/56; G06V 10/44; G06V 10/56

(52) U.S. Cl. CPC G06V 20/56; G06V 10/44; G06V 10/56

(57) ABSTRACT

The present invention provides a sensing device and a loading rate estimation system that has a high durability, enables stable sensing of the opening angle of a load compartment door, and makes it possible to minimize a decrease in the freedom of design around the load compartment door. In the present invention, a sensing device has: a recognition unit for acquiring an image obtained by imaging a part of the load compartment door in an open state, and recognising a door-corresponding portion, which is a portion corresponding to the load compartment door in the image; and a calculation unit for calculating, as the opening angle of the load compartment door, the angle between the door-corresponding portion and a reference portion.

### TECHNICAL FIELD

The present disclosure relates to a sensing apparatus and a loading rate estimation system that are used in a vehicle equipped with a cargo compartment.

### BACKGROUND ART

Conventionally, a vehicle equipped with a cargo compartment into which cargo is loaded has been known. Additionally, a sensor has been known which senses an opening angle of a door provided on an opening portion of the cargo compartment (hereinafter also referred to as a cargo-compartment door) (e.g., see Patent Literature (hereinafter referred to as “PTL”)).

### CITATION LIST

### Patent Literature

### PTL

Japanese Patent Application Laid-Open No. H04-292772

### SUMMARY OF INVENTION

### Technical Problem

The above-described sensor, however, is provided limited to a position susceptible to impact when the cargo-compartment door is opened and closed (e.g., around cargo-compartment door), which may lead to deteriorations in durability and stability of the sensor itself and a wire connected to the sensor. Further, providing the sensor around the cargo-compartment door also reduces the degree of freedom in design around the cargo-compartment door.

An object of one aspect of the present disclosure is to provide a sensing apparatus and a loading rate estimation system each capable of durably and stably sensing an opening angle of a cargo-compartment door and suppressing reduction in the degree of freedom in design around the cargo-compartment door.

### Solution to Problem

A sensing apparatus according to an aspect of the present disclosure includes: a recognition section that acquires an image of a captured portion of a cargo-compartment door in an open state, and recognizes a door-corresponding part that is a part corresponding to the cargo-compartment door in the image; and a calculation section that calculates, as an opening angle of the cargo-compartment door, an angle formed by the door-corresponding part and a reference part.

A loading rate estimation system according to an aspect of the present disclosure includes: a sensing apparatus including, a recognition section that acquires an image of a captured portion of a cargo-compartment door in an open state, and recognizes a door-corresponding part that is a part corresponding to the cargo-compartment door in the image, a calculation section that calculates, as an opening angle of the cargo-compartment door, an angle formed by the door-corresponding part and a reference part, and a determination section that determines that the cargo-compartment door is in a closed state when the opening angle is less than or equal to a predetermined threshold; and a loading rate estimation apparatus that estimates a loading rate of a vehicle equipped with the cargo-compartment door when the determination section determines that the cargo-compartment door is in the closed state.

### Advantageous Effects of Invention

According to the present disclosure, it is possible to durably and stably sense an opening angle of a cargo-compartment door and suppress reduction in the degree of freedom in design around the cargo-compartment door.

### BRIEF DESCRIPTION OF DRAWINGS

FIG. 1 is a schematic side view of a vehicle according to an embodiment of the present disclosure;

FIG. 2 is a schematic front view of a door according to the embodiment of the present disclosure;

FIG. 3 is a block diagram illustrating an exemplary configuration of a loading rate estimation system according to the embodiment of the present disclosure;

FIG. 4 schematically illustrates an exemplary cargo-compartment rear image according to the embodiment of the present disclosure;

FIG. 5 schematically illustrates exemplary door-corresponding parts, upper-edge corresponding part, and opening angles according to the embodiment of the present disclosure;

FIG. 6 is a flowchart describing an exemplary operation of a sensing apparatus according to the embodiment of the present disclosure;

FIG. 7 is a schematic side view of a vehicle according to a variation of the present disclosure; and

FIG. 8 schematically illustrates an exemplary cargo-compartment rear image according to the variation of the present disclosure.

### DESCRIPTION OF EMBODIMENTS

Hereinafter, an embodiment of the present disclosure will be described in detail with reference to the drawings. Note that, in all the drawings, an element the same as a precedent element is given the same reference numeral, and the description thereof may be omitted.

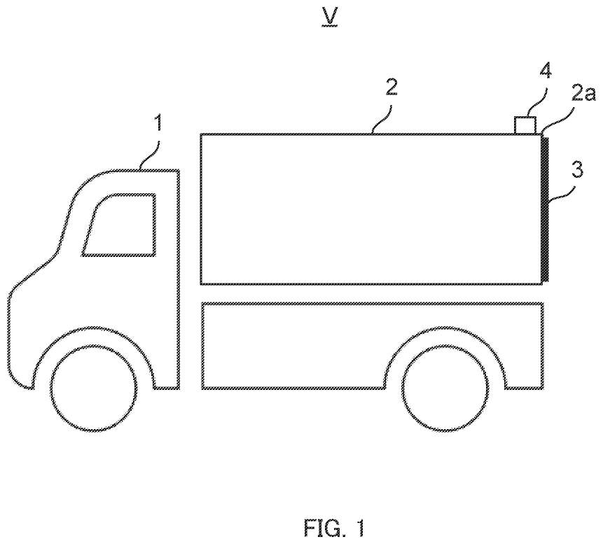

First, vehicle V of the present embodiment will be described with reference to FIG. 1. FIG. 1 is a schematic side view of vehicle V.

As illustrated in FIG. 1, vehicle V is a truck equipped with cab 1 and cargo compartment 2. Incidentally, vehicle V is not limited to a truck and may be another type of vehicle.

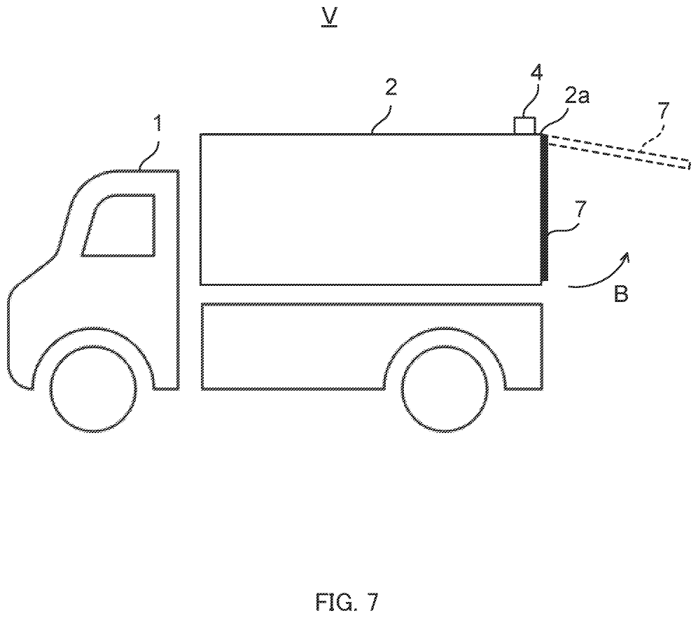

Cargo compartment 2 is box-shaped and has an opening portion (not illustrated; the same applies hereinafter) on a rear side surface, for example. Loading and unloading of cargo are carried out through the opening portion. Incidentally, in FIG. 1, the illustration of cargo in cargo compartment 2 is omitted (the same applies to FIG. 7).

At the rear of cargo compartment 2, door 3, which is openable and closable (example of cargo-compartment door), is provided such that the door corresponds to a position of the opening portion. Upper edge portion 2a is an upper edge portion of a rear surface (surface on which opening portion is provided) of cargo compartment 2.

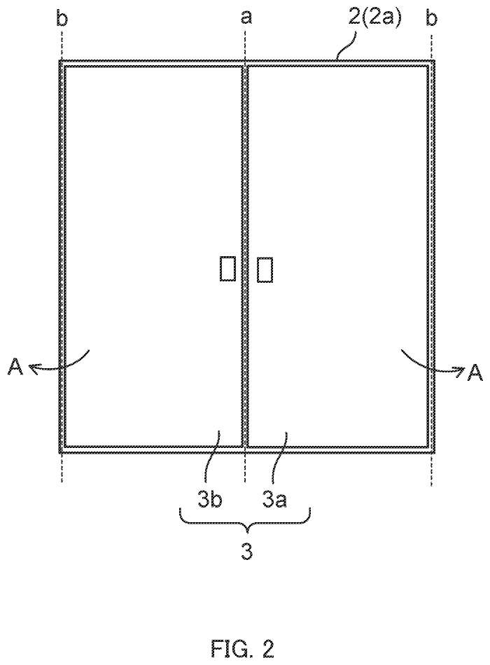

Here, door 3 will be described with reference to FIG. 2. FIG. 2 is a schematic front view of door 3.

As illustrated in FIG. 2, door 3 is a double-opening type (which may be referred to as hinged-double type) door including right door 3a and left door 3b. FIG. 2 illustrates a situation where right door 3a and left door 3b are closed (hereinafter also referred to as a closed state).

Right door 3a and left door 3b each rotate about an axis in a vertical direction (may be referred to as height direction of cargo compartment 2). More specifically, right door 3a and left door 3b respectively open by rotating, in a left and right direction (see arrow A) from a center of the opening portion (see dotted line a), about the axes in the vertical direction, which are left and right edges (see dotted lines b) of the rear surface of cargo compartment 2 (surface on which opening portion is provided).

Door 3 has been described above; hereinafter, returning to the description of FIG. 1.

Vehicle V is provided, on an upper surface of the rear of cargo compartment 2, with camera 4 for capturing an outside and rearward of vehicle V (specifically, near outside of door 3). Camera 4 is installed so that a portion of door 3 in an open state (specifically, upper surface portions of right door 3a and left door 3b) can be captured. An installation position of camera 4 is not limited to the position illustrated in FIG. 1.

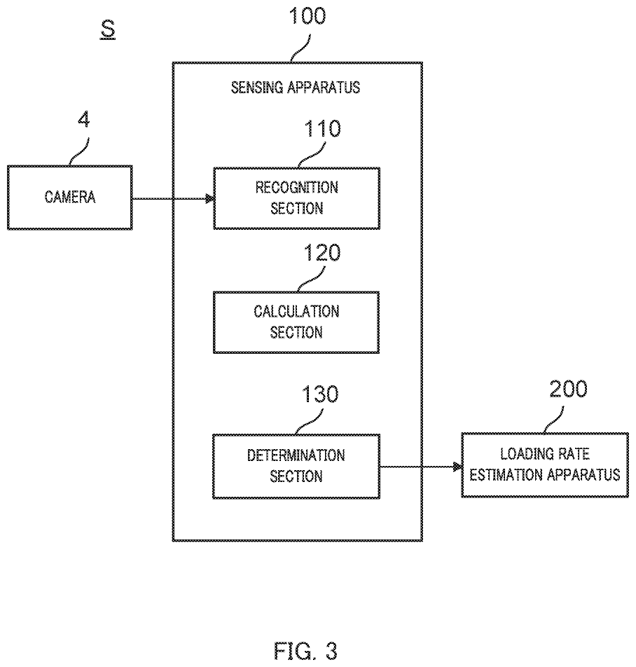

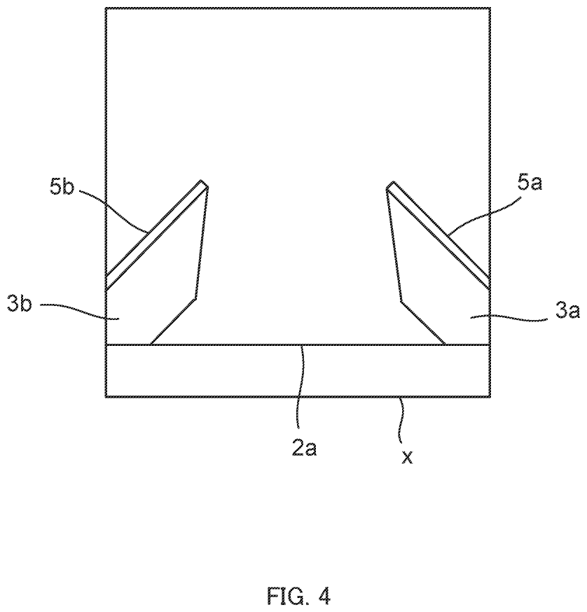

Camera 4 transmits a rearward image of cargo compartment 2, which is obtained by capturing (hereinafter referred to as a cargo-compartment rear image), to sensing apparatus 100 to be described later (see FIG. 3). The cargo-compartment rear image will be described later in detail with reference to FIG. 4.

Although not illustrated in FIG. 1, a depth sensor is provided in cargo compartment 2. The depth sensor is a sensor capable of measuring a distance from itself to a person and/or an object in two dimension. A sensing result of the depth sensor is output to loading rate estimation apparatus 200 to be described later (see FIG. 3).

Moreover, although not illustrated in FIG. 1, sensing apparatus 100 and loading rate estimation apparatus 200 to be described later (see FIG. 3) are further mounted on vehicle V.

Vehicle V has been described, thus far.

Next, loading rate estimation system S of the present embodiment will be described with reference to FIG. 3. FIG. 3 is a block diagram illustrating an exemplary configuration of loading rate estimation system S.

Loading rate estimation system S illustrated in FIG. 3 is mounted on vehicle V illustrated in FIG. 1.

As illustrated in FIG. 3, loading rate estimation system S includes sensing apparatus 100 and loading rate estimation apparatus 200 in addition to camera 4 illustrated in FIG. 1.

Although not illustrated, sensing apparatus 100 and loading rate estimation apparatus 200 each include, as hardware, a Central Processing Unit (CPU), a Read Only Memory (ROM) that stores computer programs therein, and a Random Access Memory (RAM), for example. The functions of the apparatuses described below are realized by the CPU executing a computer program read from the ROM in the RAM. For example, sensing apparatus 100 and loading rate estimation apparatus 200 may be realized by an Electronic Control Unit (ECU).

Loading rate estimation apparatus 200 is an apparatus that estimates a loading rate based on a sensing result of the depth sensor. The loading rate is a ratio of a volume of cargo placed in cargo compartment 2 to the maximum loading volume of vehicle V.

A publicly known technique can be applied to an estimation method of the loading rate performed in loading rate estimation apparatus 200. Examples of the publicly known techniques include but are not limited to, for example, methods disclosed in Japanese Patent Application Laid Open No. 2003-35527, <URL:https://creanovo.de/portfolio/wabco-cargocam/>, <URL:https://www.ncos.cojp/news/news_210113.html>, and the like.

Loading rate estimation apparatus 200 executes estimation of a loading rate when receiving, from sensing apparatus 100, information indicating that door 3 is in a closed state.

Sensing apparatus 100 is an apparatus that recognizes, based on a cargo-compartment rear image acquired from camera 4, a part corresponding to door 3 and then calculates an opening angle of door 3 (hereinafter simply referred to as an “opening angle”) on the basis of the recognition result. Moreover, sensing apparatus 100 is an apparatus that determines whether door 3 is in an open state or a closed state by comparing the calculated opening angle with a threshold.

As illustrated in FIG. 3, sensing apparatus 100 includes recognition section 110, calculation section 120, and determination section 130.

Recognition section 110 acquires a cargo-compartment rear image from camera 4.

Here, an example of the cargo-compartment rear image captured with camera 4 will be described with reference to FIG. 4. FIG. 4 schematically illustrates an exemplary cargo-compartment rear image.

The cargo-compartment rear image illustrated in FIG. 4 is a color image. As illustrated in FIG. 4, the cargo-compartment rear image includes, for example, an image of right door 3a in the open state (hereinafter referred to as a right-door 3a image), an image of left door 3b in the open state (hereinafter referred to as a left-door 3b image), and an image of upper edge portion 2a of the rear of cargo compartment 2 (hereinafter referred to as an upper-edge portion 2a image).

The right-door 3a image includes an image of upper surface portion 5a of right door 3a. The left-door 3b image includes an image of upper surface portion 5a of door 3a. Each of upper surface portion 5a, upper surface portion 5b, and upper edge portion 2a is given a predetermined color (e.g., red).

The exemplary cargo-compartment rear image has been described above; hereinafter, returning to the description of FIG. 3.

Recognition section 110 recognizes a door-corresponding part (see below for details), which is a part (may also be referred to as an area; the same applies hereinafter) corresponding to door 3 in the cargo-compartment rear image. In addition, recognition section 110 recognizes, in the cargo-compartment rear image, an upper-edge corresponding part (see below for details), which is a part corresponding to upper edge portion 2a.

Calculation section 120 calculates an angle formed by the door-corresponding part and the upper-edge corresponding part. The calculated angle is an opening angle of door 3.

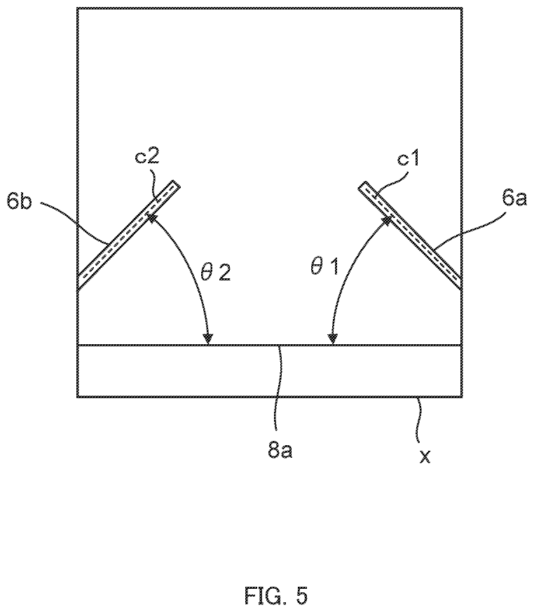

Here, with reference to FIG. 5, descriptions will be given of an exemplary method of recognizing a door-corresponding part and an upper-edge corresponding part and an exemplary method of calculating an opening angle. FIG. 5 schematically illustrates examples of the door-corresponding parts, upper-edge corresponding part, and opening angles.

First, recognition section 110 performs, on the cargo-compartment rear image illustrated in FIG. 4, filtering processing to extract the color applied to each of upper surface portion 5a, upper surface portion 5b, and upper edge portion 2a. This enables calculation section 120 to recognize (may be referred to as identify), in the cargo-compartment rear image, upper-surface corresponding parts 6a and 6b and upper-edge corresponding part 8a illustrated in FIG. 5.

Upper-surface corresponding part 6a is a part corresponding to upper surface portion 5a (see FIG. 4) in the cargo-compartment rear image. Upper-surface corresponding part 6b is a part corresponding to upper surface portion 5b (see FIG. 4) in the cargo-compartment rear image. Upper-surface corresponding parts 6a and 6b are exemplary door-corresponding parts.

Upper-edge corresponding part 8a is a part corresponding to upper edge portion 2a (see FIG. 4) in the cargo-compartment rear image. Upper-edge corresponding part 8a is a straight line in a horizontal direction. Upper-edge corresponding part 8a is an exemplary reference part.

Recognition section 110 then detects line segments c1 and c2 illustrated in FIG. 5 based on upper-surface corresponding parts 6a and 6b, respectively. Line segment c1 is a line segment along a longitudinal direction of upper-surface corresponding part 6a. Line segment c2 is a line segment along a longitudinal direction of upper-surface corresponding part 6b. Line segments c1 and c2 may also be referred to as exemplary door-corresponding parts.

Recognition section 110 then detects a line segment based on upper-edge corresponding part 8a. Since this line segment overlaps upper-edge corresponding part 8a, the illustration and reference numeral thereof are omitted in FIG. 5. Hereinafter, this line segment is referred to as a reference line segment. The reference line segment may also be referred to as an exemplary reference part.

Next, calculation section 120 calculates angle θ1 formed by line segment c1 and the reference line segment. Similarly, calculation section 120 calculates angle θ2 formed by line segment c2 and the reference line segment. Angles θ1 and θ2 are exemplary opening angles of door 3 (specifically, opening angles of door 3a and door 3b, respectively).

In the above description, a case has been given as an example where upper-edge corresponding part 8a is set as a reference part and a reference line segment is then detected, but the present disclosure is not limited to this case. In one example, when the cargo-compartment rear image includes no upper-edge portion 2a image (i.e., when camera 4 does not capture upper edge portion 2a), lower edge portion x of the cargo-compartment rear image illustrated in FIG. 5 may be used as a reference part. In this case, calculation section 120 calculates an angle formed by line segment c1 and lower edge portion x as an opening angle of door 3a, and calculates an angle formed by line segment c2 and lower edge portion x as an opening angle of door 3b. Note that lower edge portion x is a straight line in a horizontal direction, as with upper-edge corresponding part 8a.

The exemplary method of recognizing a door-corresponding part and an upper-edge corresponding part and the exemplary method of calculating an opening angle have been each described above; hereinafter, returning to the description of FIG. 3.

Determination section 130 compares an opening angle calculated by calculation section 120 with a predetermined threshold. Then, determination section 130 determines that door 3 is in an open state when the opening angle is greater than the threshold, and determines that door 3 is in a closed state when the opening angle is less than or equal to the threshold.

By way of example, determination section 130 determines that door 3 is in the closed state when both of angles θ1 and θ2 illustrated in FIG. 5 are less than or equal to the threshold. Further, for example, determination section 130 determines that door 3 is in the open state when at least one of angles θ1 and θ2 illustrated in FIG. 5 is greater than the threshold.

The threshold is a value at which right door 3a and left door 3b can be regarded to be in the closed state and is set based on results of previously conducted experiments, simulations, or the like. The threshold may be, for example, a positive number close to zero or may be zero.

When determining that door 3 is in the closed state, determination section 130 transmits (outputs), to loading rate estimation apparatus 200, determination-result information indicating that door 3 is in the closed state. Loading rate estimation apparatus 200, which has received this determination-result information, performs estimation of a loading rate.

The configurations of loading rate estimation system S and sensing apparatus 100 have been each described, thus far.

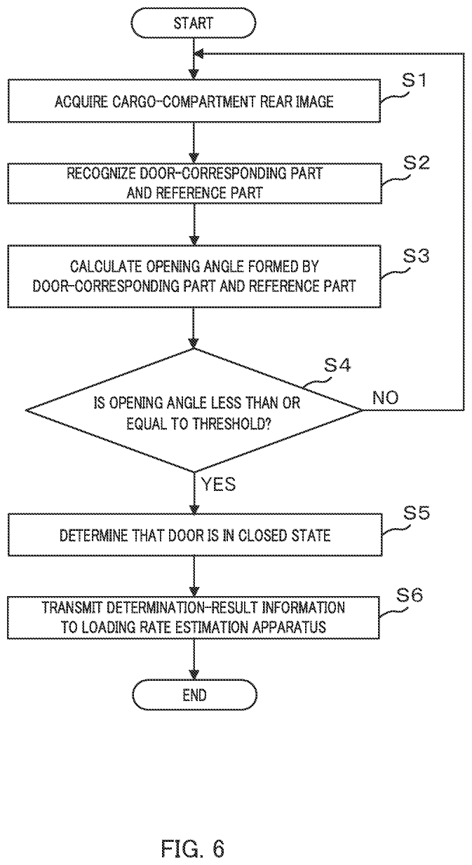

Next, an operation of sensing apparatus 100 will be described with reference to FIG. 6. FIG. 6 is a flowchart describing an exemplary operation of sensing apparatus 100. The flow of FIG. 6 is started at the time of stop of vehicle V and is repeatedly performed during the stop of vehicle V, for example.

First, recognition section 110 acquires a cargo-compartment rear image from camera 4 (step 5S1).

Recognition section 110 then recognizes a door-corresponding part in the cargo-compartment rear image (e.g., upper-surface corresponding parts 6a and 6b illustrated in FIG. 5, more specifically, for example, line segments c1 and c2 illustrated in FIG. 5) and a reference part (e.g., upper-edge corresponding part 8a or lower edge portion x illustrated in FIG. 5) (step S2).

Next, calculation section 120 calculates an opening angle formed by the door-corresponding part and the reference part (step S3).

Next, determination section 130 determines whether the calculated opening angle is less than or equal to a threshold (step S4).

When the opening angle is not less than or equal to the threshold (step S4: NO), the flow returns to step S1. Herein, the case where “the opening angle is not less than or equal to the threshold” is, for example, a case where at least one of angles θ1 and θ2 illustrated in FIG. 5 is greater than the threshold.

On the other hand, when the opening angle is less than or equal to the threshold (step S4: YES), determination section 130 determines that door 3 is in a closed state (step S5). Herein, the case where “the opening angle is less than or equal to the threshold” is, for example, a case where both of angles θ1 and θ2 illustrated in FIG. 5 are less than or equal to the threshold.

Determination section 130 then transmits, to loading rate estimation apparatus 200, determination-result information indicating that door 3 is in the closed state (step S6). Loading rate estimation apparatus 200, which has received this determination-result information, performs estimation of a loading rate.

The operation of sensing apparatus 100 has been described, thus far.

As described in detail above, sensing apparatus 100 of the present embodiment is characterized by acquiring an image (e.g., cargo-compartment rear image) in which a portion (e.g., upper surface portions 5a and 5b) of door 3 in an open state is captured and calculating, as an opening angle of door 3, an angle (e.g., angles θ1 and θ2) formed by a door-corresponding part (e.g., upper-surface corresponding parts 6a and 6b), which is a part corresponding to door 3 in the image, and a predetermined reference part (e.g., upper-edge corresponding part 8a).

Thus, sensing apparatus 100 of the present embodiment is capable of calculating an opening angle without using a sensor installed around a cargo-compartment door, as in PTL, for example. Hence, it is possible to durably and stably sense an opening angle of a cargo-compartment door and suppress reduction in the degree of freedom in design around the cargo-compartment door.

Further, sensing apparatus 100 of the present embodiment is characterized by determining an open/closed state of door 3 based on a calculated opening angle.

Thus, sensing apparatus 100 of the present embodiment is capable of determining the open/closed state of door 3 based on the calculated opening angle, without using a sensor installed around a cargo-compartment door, as in PTL, for example. Hence, it is possible to durably and stably determine an open/closed state of a cargo-compartment door and suppress reduction in the degree of freedom in design around the cargo-compartment door.

Meanwhile, loading rate estimation system S of the present embodiment is characterized in that loading rate estimation apparatus 200 performs estimation of a loading rate when sensing apparatus 100 determines that door 3 is in a closed state.

When a loading rate is estimated while an operator is in cargo compartment 2, the operator is treated in the same manner as cargo, which deteriorates the estimation accuracy of the loading rate. In loading rate estimation system S of the present embodiment, a loading rate is estimated when door 3 is in a closed state (i.e., when operator is not in cargo compartment 2), thus improving the estimation accuracy.

The present disclosure is not limited to the description of the above embodiment, and various modifications can be made without departure from the spirit of the disclosure. In the following, variations will be described.

### Variation 1

In the embodiment, a case has been described as an example where the cargo-compartment door is a door that rotates in a left and right direction about an axis in a vertical direction, but the present disclosure is not limited to this case.

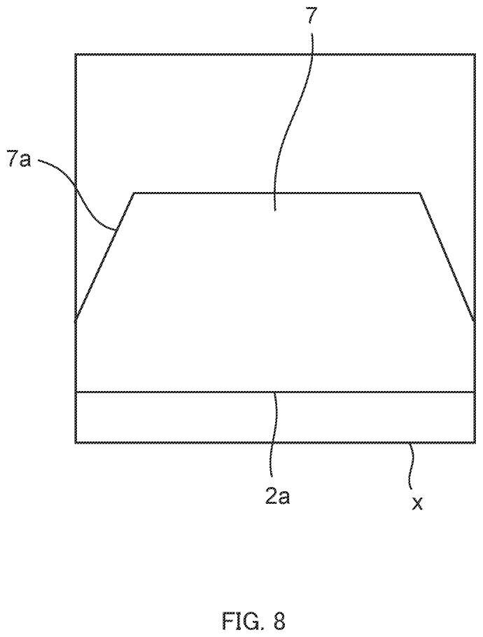

For example, the cargo-compartment door may be a door that rotates in an upward and downward direction about an axis in a horizontal direction. This example will be described below with reference to FIGS. 7 and 8.

FIG. 7 is a schematic side view of vehicle V according to the present variation. FIG. 8 schematically illustrates an exemplary cargo-compartment rear image according to the present variation. In FIGS. 7 and 8, the components same as those in FIGS. 1 and 4 are given the same reference numerals.

As illustrated in FIG. 7, at the rear of cargo compartment 2, door 7 is provided instead of door 3 illustrated in FIG. 1 and the like.

Door 7 rotates about an axis in a horizontal direction (may be referred to as width direction of cargo compartment 2). More specifically, door 7 opens by rotating, in an upward direction (see arrow B) from a lower edge side of an opening portion, about the axis in the horizontal direction, which is upper edge portion 2a of a rear surface of cargo compartment 2 (surface on which opening portion is provided). In FIG. 7, door 7 indicated by a dotted line illustrates its open state.

The cargo-compartment rear image illustrated in FIG. 8 is a color image. As illustrated in FIG. 8, the cargo-compartment rear image includes, for example, an image of door 7 in the open state (hereinafter referred to as a door 7 image).

The door 7 image includes an image of side edge portion 7a of door 7. Side edge portion 7a is given a predetermined color (e.g., red).

First, recognition section 110 acquires the cargo-compartment rear image illustrated in FIG. 8 from camera 4 and performs, on the cargo-compartment rear image, filtering processing to extract the color applied to each of side edge portion 7a and upper edge portion 2a. Although not illustrated, this enables recognition section 110 to recognize (may be referred to as identify), in the cargo-compartment rear image, a side-edge corresponding part that is a part corresponding to side edge portion 7a and an upper-edge corresponding part that is a part corresponding to upper edge portion 2a (e.g., reference numeral 8a illustrated in FIG. 5). The side-edge corresponding part is an exemplary door-corresponding part.

Recognition section 110 then detects a line segment (not illustrated; hereinafter referred to as a first line segment) based on the side-edge corresponding part. This first line segment is a line segment along a longitudinal direction of the side-edge corresponding part (may be referred to as side edge portion 7a). The first line segment may also be referred to as an exemplary door-corresponding part. In addition, recognition section 110 detects a reference line segment (not illustrated; example of reference part) based on the upper-edge corresponding part, as in the embodiment.

Next, calculation section 120 calculates, as an opening angle, an angle formed by the detected first line segment and the reference line segment (or may be lower edge portion x).

The subsequent determination processing by determination section 130 is similar to that in the embodiment.

Incidentally, door 7 may be foldable at the lower edge portion thereof during the open state.

Further, in the embodiment and the present variation, a case has been described as an example where the cargo-compartment door is a door provided at the rear of cargo compartment 2, but the present disclosure is not limited to this case, and the cargo-compartment door may be, for example, a door provided on a side of cargo compartment 2.

### Variation 2

In the embodiment, recognition section 110 may recognize in real time a door-corresponding part and an upper-edge corresponding part (may recognize only door-corresponding part when using lower edge portion x), and calculation section 120 may calculate an opening angle in real time. Then, determination section 130 may determine an open/closed state of door 3 in accordance with a temporal change in opening angle calculated in real time. In one example, determination section 120 determination section 130 may determine that door 3 is being opened when the opening angle increases with time, and may determine that door 3 is being closed when the opening angle decreases with time.

### Variation 3

In the embodiment, a case has been given as an example where a portion of door 3 (e.g., upper surface portion 5a, upper surface portion 5b, and upper edge portion 2a) is given a predetermined color and recognition section 110 then recognizes a door-corresponding part (e.g., upper-surface corresponding parts 6a and 6b) and a reference part (e.g., upper-edge corresponding part 8a) by performing, on the cargo-compartment rear image, the filtering processing based on the color. However, the present disclosure is not limited to this case.

In one example, recognition section 110 may recognize a door-corresponding part (and upper-edge corresponding part) by performing, on the cargo-compartment rear image, processing such as “edge-detection+polygonal detection” or “image recognition using deep learning,” which is a publicly known technique. However, this processing is costly because a high computational capability is required as compared with that for the filtering processing described in the embodiment.

### Variation 4

In the embodiment, a case has been described as an example where sensing apparatus 100 and loading rate estimation apparatus 200 are provided separately, but the present disclosure is not limited to this case.

In one example, sensing apparatus 100 may have a function of loading rate estimation apparatus 200 (may be referred to as a loading rate estimation section). In this case, camera 4 and sensing apparatus 100 may be referred to as a loading rate estimation system in combination.

Further, in the embodiment, a case has been described as an example where sensing apparatus 100 and loading rate estimation apparatus 200 are mounted on vehicle V, but the present disclosure is not limited to this case. In one example, at least one of sensing apparatus 100 and loading rate estimation apparatus 200 may be realized by a computer (e.g., server and the like) installed outside vehicle V. In this case, for example, a communication apparatus mounted on vehicle V (not illustrated) may transmit, to the computer, a cargo-compartment rear image or determination-result information.

### Variation 5

In the embodiment, a case has been described as an example where the determination-result information indicating that door 3 is in the closed state is transmitted to loading rate estimation apparatus 200, but the present disclosure is not limited to this case.

In one example, determination section 130 may transmit determination-result information indicating either an open state or a closed state of door 3 to a broadcast apparatus provided in cab 1 (not illustrated; e.g., display, speaker, and the like). In this case, the broadcast apparatus performs image displaying and/or sound outputting that indicate(s) either an open state or a closed state. This allows a user (e.g., occupant of vehicle V, operator carrying out loading or unloading, or the like) to recognize an open/closed state of door 3.

### Variation 6

Further, in the embodiment, a case has been described as an example where sensing apparatus 100 includes determination section 130, but determination section 130 may be realized by an apparatus physically separate from sensing apparatus 100. That is, sensing apparatus 100 may be configured to include at least recognition section 110 and calculation section 120. In this case, calculation section 110 may output (transmit) information indicating a calculated opening angle to a predetermined apparatus (e.g., computer mounted on vehicle V, computer installed outside vehicle V, broadcast apparatus described in above variation 5, or the like).

The variations have been each described, thus far. Note that the above variations may be combined with each other as appropriate.

This application is based on Japanese Patent No. 2021-049745 filed on Mar. 24, 2021, the disclosure of which including the specification, drawings and abstract is incorporated herein by reference in its entirety.

### INDUSTRIAL APPLICABILITY

A sensing apparatus and a loading rate estimation system of the present disclosure are useful for a vehicle equipped with a cargo compartment.

### REFERENCE SIGNS LIST

1 Cab
2 Cargo compartment
2a Upper edge portion of rear of cargo compartment 2
3, 7 Door
3a Right door
3b Left door
4 Camera
5a Upper surface portion of right door 3a
5b Upper surface portion of left door 3b
6a, 6b Upper-surface corresponding part
8a Upper-edge corresponding part
100 Sensing apparatus
110 Recognition section
120 Calculation section
130 Determination section
200 Loading rate estimation apparatus
S Loading rate estimation system
V Vehicle

1. A sensing apparatus, comprising:
a recognition section that acquires an image of a captured portion of a cargo-compartment door in an open state, and recognizes a door-corresponding part that is a part corresponding to the cargo-compartment door in the image; and
a calculation section that calculates, as an opening angle of the cargo-compartment door, an angle formed by the door-corresponding part and a reference part.

2. The sensing apparatus according to claim 1, further comprising a determination section that determines that the cargo-compartment door is in a closed state when the opening angle is less than or equal to a predetermined threshold.

3. The sensing apparatus according to claim 2, wherein:
the recognition section recognizes in real time the door-corresponding part,
the calculation section calculates in real time the opening angle based on the door-corresponding part, and
the determination section determines that the cargo-compartment door is being opened when the opening angle increases with time, and determines that the cargo-compartment door is being closed when the opening angle decreases with time.

4. The sensing apparatus according to claim 1, wherein,
the cargo-compartment door is partly given a predetermined color, and wherein,
the recognition section
recognizes the door-corresponding part by performing, on the image, filtering based on the predetermined color,
detects a line segment along a longitudinal direction of the door-corresponding part, and
calculates, as the opening angle, an angle formed by the line segment and a straight line serving as the reference part.

5. The sensing apparatus according to claim 1, wherein the cargo-compartment door is a door that rotates in a left and right direction about an axis in a vertical direction.

6. The sensing apparatus according to claim 1, wherein the cargo-compartment door is a door that rotates in an upward and downward direction about an axis in a horizontal direction.

7. The sensing apparatus according to claim 1, wherein the image is an image captured with a camera that is mounted on a vehicle equipped with the cargo-compartment door and captures an outside of the vehicle.

8. The sensing apparatus according to claim 1, further comprising a loading rate estimation section that estimates a loading rate of a vehicle equipped with the cargo-compartment door when the cargo-compartment door is determined as in a closed state.

9. The sensing apparatus according to claim 2, wherein, when determining that the cargo-compartment door is in the closed state, the determination section transmits information indicating that the cargo-compartment door is in the closed state to a loading rate estimation apparatus that estimates a loading rate of a vehicle equipped with the cargo-compartment door.

10. A loading rate estimation system, comprising:
a sensing apparatus including,
a recognition section that acquires an image of a captured portion of a cargo-compartment door in an open state, and recognizes a door-corresponding part that is a part corresponding to the cargo-compartment door in the image,
a calculation section that calculates, as an opening angle of the cargo-compartment door, an angle formed by the door-corresponding part and a reference part, and
a determination section that determines that the cargo-compartment door is in a closed state when the opening angle is less than or equal to a predetermined threshold; and
a loading rate estimation apparatus that estimates a loading rate of a vehicle equipped with the cargo-compartment door when the determination section determines that the cargo-compartment door is in the closed state.
